(19) United States
(12) Patent Application Publication
(10) Pub. No.: US 2026/0370882 A1
(43) Pub. Date: Nov. 19, 2026

(54) DECODER, ENCODER AND CORRESPONDING METHODS FOR PREDICTION-BASED RESIDUAL CODING

(71) Applicant: Fraunhofer-Gesellschaft zur Förderung der angewandten Forschung e.V., München (DE)

(72) Inventors: Gerhard TECH, Berlin (DE); Jonathan PFAFF, Berlin (DE); Heiko SCHWARZ, Berlin (DE); Detlev MARPE, Berlin (DE); Thomas WIEGAND, Berlin (DE)

(21) Appl. No.: 19/735,065

(22) Filed: Jul. 8, 2026

Related U.S. Application Data
(63) Continuation of application No. PCT/EP2025/050342, filed on Jan. 8, 2025.

(30) Foreign Application Priority Data
Jan. 9, 2024 (EP) 24151063.5

(51) Int. Cl. H04N 19/61; H04N 19/12; H04N 19/172; H04N 19/176; H04N 19/42

(52) U.S. Cl. CPC H04N 19/61; H04N 19/12; H04N 19/172; H04N 19/176; H04N 19/42

(57) ABSTRACT

A Block-based predictive decoder for decoding pictures from a data stream is configured to derive a prediction residual block of a currently decoded block based on a predicted block of the currently decoded block, and reconstruct the currently decoded block based on the prediction residual block and the predicted block.

### CROSS-REFERENCE TO RELATED APPLICATIONS

This application is a continuation of copending International Application No. PCT/EP2025/050342, filed Jan. 8, 2025, which is incorporated herein by reference in its entirety, and additionally claims priority from European Application No. EP 24151063.5, filed Jan. 9, 2024, which is also incorporated herein by reference in its entirety.

Embodiments according to the invention relate to Decoder, encoder and corresponding methods for prediction-based residual coding, especially for prediction-based residual encoding and prediction-based residual reconstruction.

### BACKGROUND OF THE INVENTION

The most common video codecs, like AVC, HEVC, and VVC, encode the pictures of a video in a block-based manner, where the video signal within a block of a picture is first predicted from other pictures (inter-picture prediction) or from neighboring samples within the same picture (intra-picture prediction). Additionally, a residual signal, which compensates the prediction errors, is transmitted. The residual signal is usually derived by subtracting the prediction signal from the original video signal. For efficient transmission, the residual signal is transformed; the resulting transform coefficients are then quantized and entropy encoded.

At the decoder side, the quantization indices are entropy decoded, dequantized, and inverse transformed to obtain the reconstructed residual signal. Finally, the reconstructed residual signal is added to the prediction signal, which is derived in same manner as at the encoder. Note that, due to the lossy nature of quantization, a perfect reconstruction or the residual signal is not possible. Conventionally, to allow for parallel execution of prediction and residual decoding, the residual decoding process is independent from the prediction process.

It is desired to provide concepts for rendering picture coding and/or video coding more efficient. Additionally or alternatively, it is desired to reduce a bit stream and thus a signalization cost.

### SUMMARY

An embodiment may have a video decoder configured to derive one or more prediction signals; reconstructing a residual signal from a bitstream; and combining the reconstructed residual signal and the one or more prediction signals, in which the reconstruction of the residual signal depends on the one or more prediction signals.

Another embodiment may have a block-based predictive decoder for decoding pictures from a data stream configured to derive a prediction residual block of a currently decoded block based on a predicted block of the currently decoded block, and reconstruct the currently decoded block based on the prediction residual block and the predicted block.

Another embodiment may have a block-based predictive encoder for encoding pictures into a data stream configured to derive a prediction residual block of a currently encoded block based on a predicted block of the currently encoded block so that the currently encoded block is reconstructable based on the prediction residual block and the predicted block.

Another embodiment may have a method performed by the inventive block-based predictive decoder.

According to another embodiment, a method for decoding pictures from a data stream may have the steps of deriving a prediction residual block of a currently decoded block based on a predicted block of the currently decoded block, and reconstructing the currently decoded block based on the prediction residual block and the predicted block.

Another embodiment may have a method performed by the inventive block-based predictive encoder.

According to another embodiment, a method for encoding pictures into a data stream may have the steps of: deriving a prediction residual block of a currently encoded block based on a predicted block of the currently encoded block so that the currently encoded block is reconstructable based on the prediction residual block and the predicted block.

Data stream generated by the inventive method for decoding or by the inventive block-based predictive encoder.

A computer program for implementing any of the inventive methods when being executed on a computer or signal processor

In accordance with an aspect of the present invention, the inventors of the present application realized that a prediction residual signal, e.g., a residual signal, could be more efficiently encoded and decoded, if a prediction signal is considered. This is based on the idea that information in the prediction signal could be valuable for encoding and decoding the residual signal, e.g., in terms of improving the prediction residual signal itself, so that same could be encoded and decoded more efficiently or with a reduced signalization cost, or in terms of improving a residual encoding/decoding tool, like a transform module, so that the prediction residual signal could be encoded and decoded more efficiently. The inventors found, that the additional information provided by a prediction signal improves the encoding/decoding efficiency for the residual signal, even though such a consideration of a prediction signal prevents a parallel execution of a prediction process and a residual encoding/decoding.

Accordingly, in accordance with this aspect of the present application, a picture or video decoder is configured to derive one or more prediction signals (e.g., generate or predict the one or more prediction signals, prediction blocks or predicted blocks); reconstruct a residual signal from a bitstream/datastream (e.g., decode a quantized residual signal (e.g., quantization indices associated with the residual signal) from a bitstream/datastream, dequantize the quantized residual signal to obtain a dequantized residual signal, and inverse transform the dequantized residual signal to obtain a reconstructed residual signal); and combine the residual signal, e.g., the reconstructed residual signal, and the one or more prediction signals (e.g., to obtain a reconstructed signal, e.g., of a block of a picture, of a picture or of a video). The reconstruction of the residual signal depends on the one or more prediction signals. For example, the picture or video decoder is configured to reconstruct the residual signal dependent on the one or more prediction signals.

A corresponding picture or video encoder may be configured to derive one or more prediction signals; encode a residual signal into a bitstream; and combine the residual signal and the one or more prediction signals. The encoding of the residual signal depends on the one or more prediction signals. The picture or video encoder is based on the same considerations as the above-described picture or video decoder. The encoder does the opposite of the decoder, wherein the prediction process is the same for encoder and decoder.

A corresponding method for picture or video encoding/decoding may be configured to derive one or more prediction signals; encode/reconstruct a residual signal into/from a bitstream dependent on the one or more prediction signals; and combine the residual signal and the one or more prediction signals.

Accordingly, in accordance with this aspect of the present application, a block-based predictive decoder for decoding pictures from a data stream is configured to derive a prediction residual block of a currently decoded block based on (e.g., dependent on) a predicted block of the currently decoded block (e.g. based on the predicted block directly or based on one or more features derived from the predicted block), and reconstruct the currently decoded block based on the prediction residual block and the predicted block. According to an embodiment, the predicted block may be one of two or more (e.g., a plurality of) predicted blocks of the currently decoded block and the block-based predictive decoder, for example, is configured to reconstruct the currently decoded block based on the prediction residual block and the two or more predicted blocks. The decoder may be configured to derive the prediction residual block of the currently decoded block based on one or more of the two or more predicted blocks, e.g., at least based on the predicted block.

A corresponding block-based predictive encoder for encoding pictures into a data stream is configured to derive (or encode) a prediction residual block of a currently encoded block based on (e.g., dependent on) a predicted block (e.g. based on the predicted block directly or based on one or more features derived from the predicted block) of the currently encoded block so that the currently encoded block is reconstructable based on the prediction residual block and the predicted block. The block-based predictive encoder is based on the same considerations as the above-described block-based predictive decoder. The encoder does the opposite of the decoder, wherein the prediction process is the same for encoder and decoder.

A corresponding method for encoding/decoding pictures into/from a data stream comprises deriving a prediction residual block of a currently encoded/decoded block based on (e.g., dependent on) a predicted block of the currently encoded/decoded block. The currently encoded/decoded block is reconstructable based on the prediction residual block and the predicted block.

It is to be noted that the features “predicted block” and “prediction signal” are used herein interchangeable. That means, the predicted block can be a prediction signal and the prediction signal can be a predicted block.

The methods as described above are based on the same considerations as the above-described encoder/decoder. The methods can, by the way, be completed with all features and functionalities, which are also described with regard to the encoder/decoder.

An embodiment is related to a data stream having a picture or a video encoded thereinto using a herein described method for encoding.

An embodiment is related to a computer program having a program code for performing, when running on a computer, a herein described method, when being executed on the computer.

### BRIEF DESCRIPTION OF THE DRAWINGS

Embodiments of the present invention will be detailed subsequently referring to the appended drawings, in which:

FIG. 1 shows an embodiment of an encoder;

FIG. 2 shows an embodiment of a decoder;

FIG. 3 shows a reconstructed signal based on a combination of a prediction residual signal and a prediction signal;

FIG. 4a shows an embodiment of a residual decoding, which depends on a prediction signal;

FIG. 4b shows an embodiment of a residual encoding, which depends on a prediction signal;

FIG. 5a shows an embodiment of a residual decoding, which depends on features of a prediction signal;

FIG. 5b shows an embodiment of a residual encoding, which depends on features of a prediction signal;

FIG. 6 shows an unmodified residual decoding;

FIG. 7a shows a residual decoding using a transform selection, which depends on a prediction signal;

FIG. 7b shows a residual encoding using a transform selection, which depends on a prediction signal;

FIG. 8a shows a residual decoding using a transform deriver, which depends on a prediction signal;

FIG. 8b shows a residual encoding using a transform deriver, which depends on a prediction signal;

FIG. 9a shows a residual decoding using in the spatial-domain a residual modification dependent on a prediction signal;

FIG. 9b shows a residual encoding using in the spatial-domain a residual modification dependent on a prediction signal;

FIG. 10a shows a residual decoding using in the spectral-domain a residual modification dependent on a prediction signal; and

FIG. 10b shows a residual encoding using in the spectral-domain a residual modification dependent on a prediction signal.

### DETAILED DESCRIPTION OF THE INVENTION

Equal or equivalent elements or elements with equal or equivalent functionality are denoted in the following description by equal or equivalent reference numerals or are identified with the same name, and a repeated description of elements provided with the same reference number or being identified with the same name is typically omitted, even if occurring in different figures. Hence, descriptions provided for elements having the same or similar reference numbers or being identified with the same names are mutually exchangeable or may be applied to one another in the different embodiments.

In the following description, a plurality of details is set forth to provide a more thorough explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

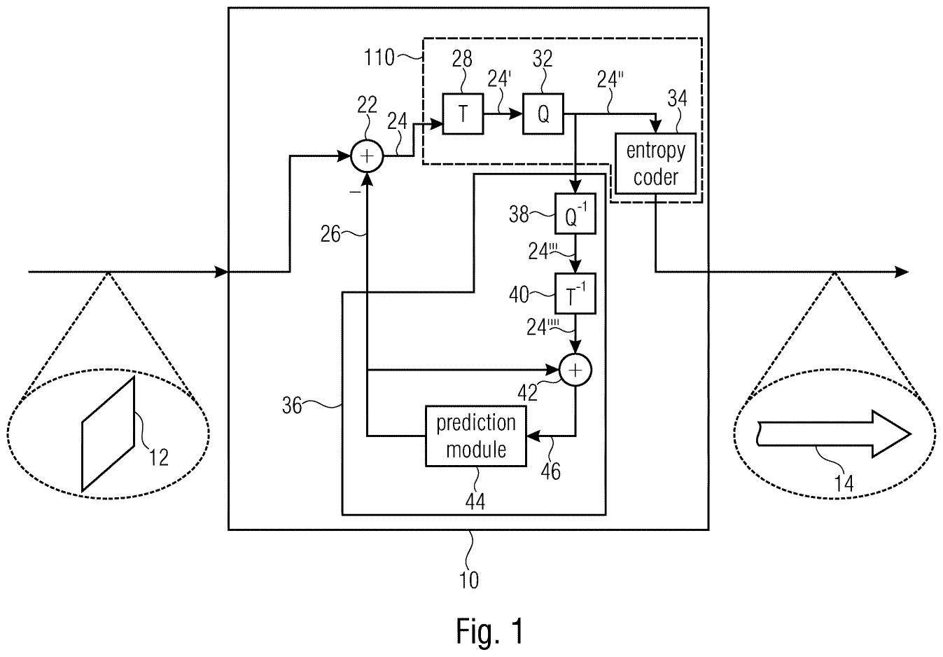

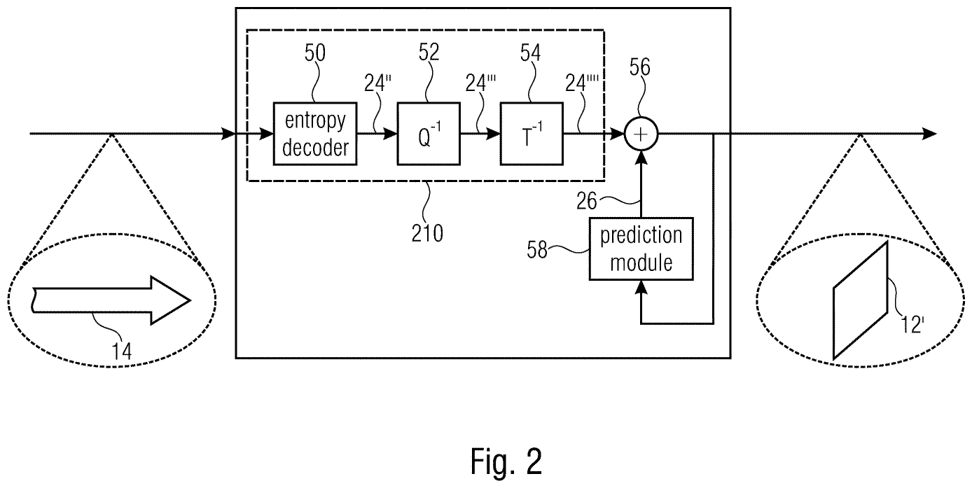

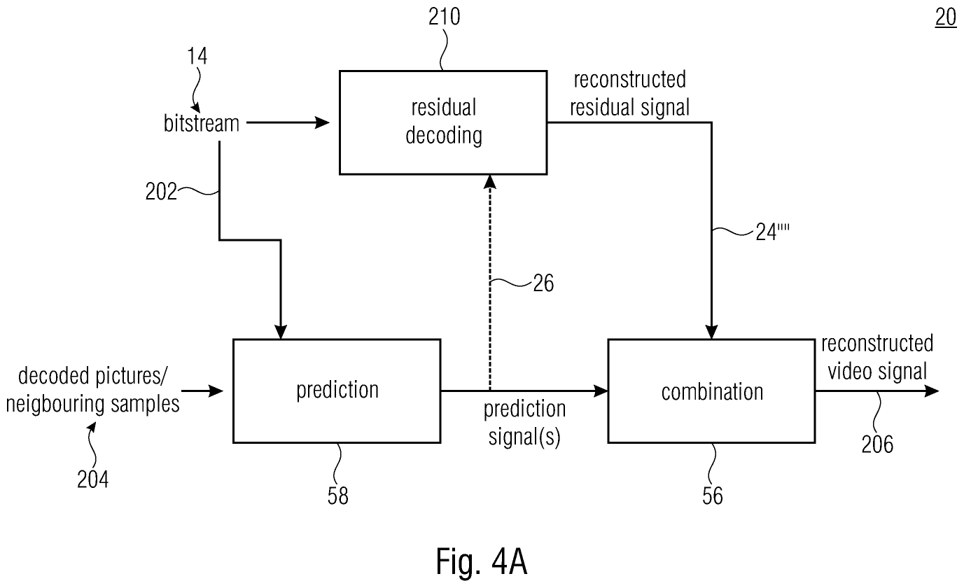

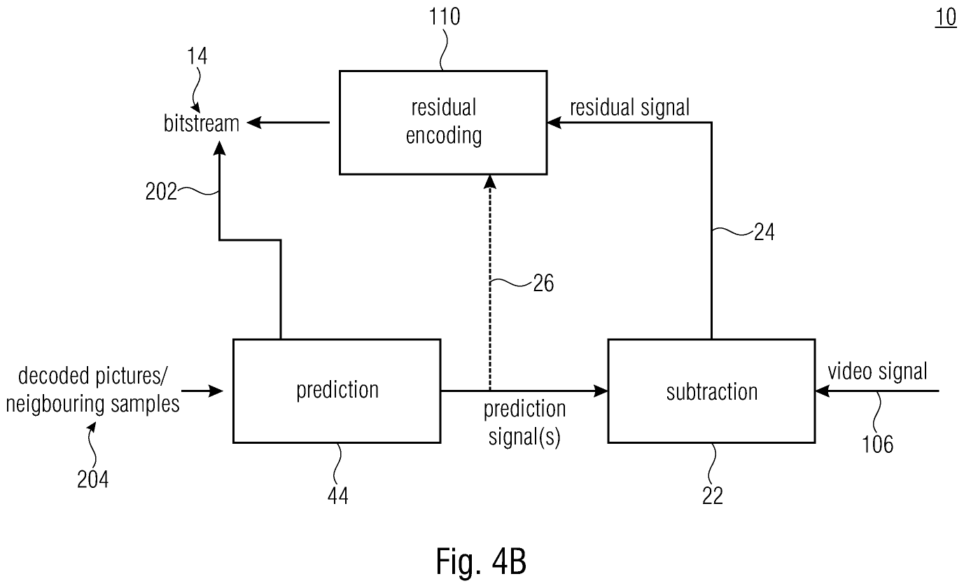

The following description of the figures starts with a presentation of a description of an encoder and a decoder of a block-based predictive codec for coding pictures of a video in order to form an example for a coding framework into which embodiments of the present invention may be built in. The respective encoder and decoder are described with respect to FIGS. 1 to 3. Thereinafter the description of embodiments of the concept of the present invention is presented along with a description as to how such concepts could be built into the encoder and decoder of FIGS. 1 and 2, respectively, although the embodiments described with the subsequent FIG. 4a and following, may also be used to form encoders and decoders not operating according to the coding framework underlying the encoder and decoder of FIGS. 1 and 2.

FIG. 1 shows an apparatus (e. g. a video encoder or picture encoder) for predictively encoding a picture 12 into a data stream 14 exemplarily using transform-based residual coding. The apparatus, or encoder, is indicated using reference sign 10. FIG. 2 shows a corresponding decoder 20, i.e. an apparatus 20 configured to predictively decode the picture 12′ from the data stream 14 also using transform-based residual decoding, wherein the apostrophe has been used to indicate that the picture 12′ as reconstructed by the decoder 20 deviates from picture 12 originally encoded by apparatus 10 in terms of coding loss introduced by a quantization of the prediction residual signal. FIG. 1 and FIG. 2 exemplarily use transform based prediction residual coding, although embodiments of the present application are not restricted to this kind of prediction residual coding. This is true for other details described with respect to FIGS. 1 and 2, too, as will be outlined hereinafter.

The encoder 10 is configured to subject the prediction residual signal to spatial-to-spectral transformation and to encode the prediction residual signal, thus obtained, into the data stream 14. Likewise, the decoder 20 is configured to decode the prediction residual signal from the data stream 14 and subject the prediction residual signal, thus obtained, to spectral-to-spatial transformation.

Internally, the encoder 10 may comprise a prediction residual signal former 22 which generates a prediction residual 24 so as to measure a deviation of a prediction signal 26 from the original signal, i.e. from the picture 12, wherein the prediction signal 26 can be interpreted as a prediction signal of a predictor block (predicted block) or as a linear combination of a set of one or more predictor blocks (predicted blocks) according to an embodiment of the present invention. The prediction residual signal former 22 may, for instance, be a subtractor which subtracts the prediction signal from the original signal, i.e. from the picture 12 or from a current block of the picture 12. The encoder 10 then further comprises a transformer 28 which subjects the prediction residual signal 24 to a spatial-to-spectral transformation to obtain a spectral-domain prediction residual signal 24′ which is then subject to quantization by a quantizer 32, also comprised by the encoder 10. The thus quantized prediction residual signal 24'′ is coded into bitstream 14. To this end, encoder 10 may optionally comprise an entropy coder 34 which entropy codes the prediction residual signal as transformed and quantized into data stream 14.

The prediction signal 26 or predicted block is generated by a prediction stage 36 of encoder 10 on the basis of the prediction residual signal 24″ encoded into, and decodable from, data stream 14. To this end, the prediction stage 36 may internally, as is shown in FIG. 1, comprise a dequantizer 38 which dequantizes the prediction residual signal 24″ so as to gain spectral-domain prediction residual signal 24′″, which corresponds to signal 24′ except for quantization loss, followed by an inverse transformer 40 which subjects the latter prediction residual signal 24″′ to an inverse transformation, i.e. a spectral-to-spatial transformation, to obtain prediction residual signal 24″″, which corresponds to the original prediction residual signal 24 except for quantization loss. A combiner 42 of the prediction stage 36 then recombines, such as by addition, the prediction signal 26 or predicted block and the prediction residual signal 24″″ or prediction residual block so as to obtain a reconstructed signal 46, i.e. a reconstruction of the original signal 12 or of a currently decoded/encoded block. However, it should be noted that more than one prediction signal 26 or predicted block may be combined with the prediction residual signal 24″″ or prediction residual block for the reconstruction. Reconstructed signal 46 may correspond to signal 12′ or to a block of signal 12′. A prediction module 44 of prediction stage 36 then generates the prediction signal 26 on the basis of signal 46 by using, for instance, spatial prediction, i.e. intra-picture prediction, and/or temporal prediction, i.e. inter-picture prediction.

Likewise, decoder 20, as shown in FIG. 2, may be internally composed of components corresponding to, and interconnected in a manner corresponding to, prediction stage 36. In particular, entropy decoder 50 of decoder 20 may entropy decode the quantized spectral-domain prediction residual signal 24″ from the data stream, whereupon dequantizer 52, inverse transformer 54, combiner 56 and prediction module 58, interconnected and cooperating in the manner described above with respect to the modules of prediction stage 36, recover the reconstructed signal on the basis of prediction residual signal 24″ so that, as shown in FIG. 2, the output of combiner 56 results in the reconstructed signal, namely picture 12′.

Although not specifically described above, it is readily clear that the encoder 10 may set some coding parameters including, for instance, prediction modes, motion parameters and the like, according to some optimization scheme such as, for instance, in a manner optimizing some rate and distortion related criterion, i.e. coding cost. For example, encoder 10 and decoder 20 and the corresponding modules 44, 58, respectively, may support different prediction modes such as intra-coding modes and inter-coding modes. The granularity at which encoder and decoder switch between these prediction mode types may correspond to a subdivision of picture 12 and 12′, respectively, into coding segments or coding blocks. In units of these coding segments, for instance, the picture may be subdivided into blocks being intra-coded and blocks being inter-coded.

Intra-coded blocks are predicted on the basis of a spatial, already coded/decoded neighborhood (e. g. a current template) of the respective block (e. g. a current block) as is outlined in more detail below. Several intra-coding modes may exist and be selected for a respective intra-coded segment including directional or angular intra-coding modes according to which the respective segment is filled by extrapolating the sample values of the neighborhood along a certain direction which is specific for the respective directional intra-coding mode, into the respective intra-coded segment. The intra-coding modes may, for instance, also comprise one or more further modes such as a DC coding mode, according to which the prediction for the respective intra-coded block assigns a DC value to all samples within the respective intra-coded segment, and/or a planar intra-coding mode according to which the prediction of the respective block is approximated or determined to be a spatial distribution of sample values described by a two-dimensional linear function over the sample positions of the respective intra-coded block with driving tilt and offset of the plane defined by the two-dimensional linear function on the basis of the neighboring samples.

Compared thereto, inter-coded blocks may be predicted, for instance, temporally. For inter-coded blocks, motion vectors may be signaled within the data stream 14, the motion vectors indicating the spatial displacement of the portion of a previously coded picture (e. g. a reference picture) of the video to which picture 12 belongs, at which the previously coded/decoded picture is sampled in order to obtain the prediction signal (e.g., a predicted block) for the respective inter-coded block. This means, in addition to the residual signal coding comprised by data stream 14, such as the entropy-coded transform coefficient levels representing the quantized spectral-domain prediction residual signal 24″, data stream 14 may have encoded thereinto coding mode parameters for assigning the coding modes to the various blocks, prediction parameters for some of the blocks, such as motion parameters for inter-coded segments, and optional further parameters such as parameters for controlling and signaling the subdivision of picture 12 and 12′, respectively, into the segments. The decoder 20 uses these parameters to subdivide the picture in the same manner as the encoder did, to assign the same prediction modes to the segments, and to perform the same prediction to result in the same prediction signal.

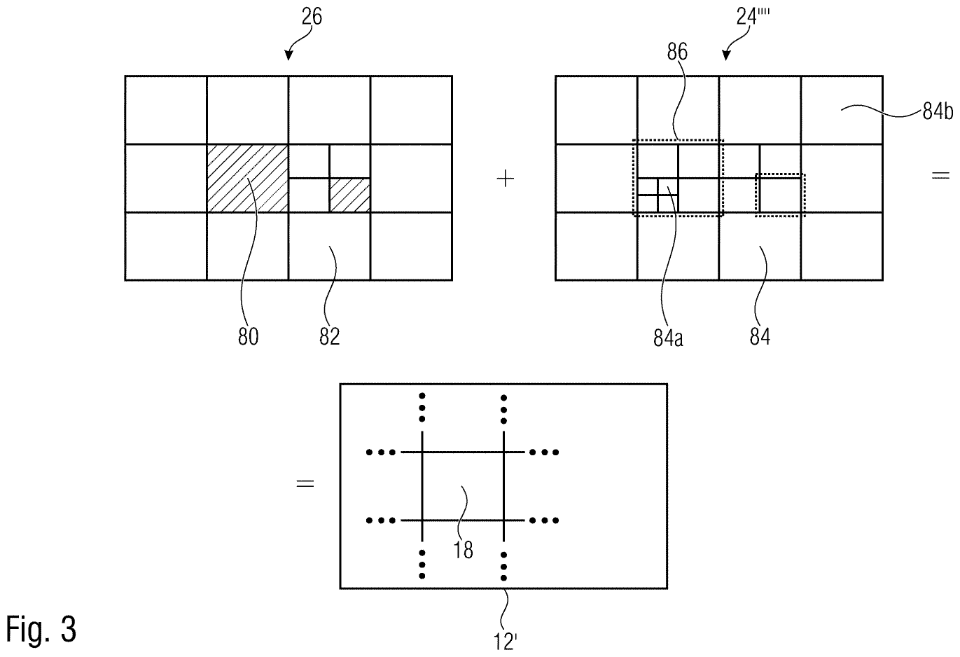

FIG. 3 illustrates the relationship between the reconstructed signal, i.e. the reconstructed picture 12′, on the one hand, and the combination of the prediction residual signal 24″″ as signaled in the data stream 14, and the prediction signal 26, on the other hand. As already denoted above, the combination may be an addition. The prediction signal 26 is illustrated in FIG. 3 as a subdivision of the picture area into intra-coded blocks which are illustratively indicated using hatching, and inter-coded blocks which are illustratively indicated not-hatched. The subdivision may be any subdivision, such as a regular subdivision of the picture area into rows and columns of square blocks or non-square blocks, or a multi-tree subdivision of picture 12 from a tree root block into a plurality of leaf blocks of varying size, such as a quadtree subdivision or the like, wherein a mixture thereof is illustrated in FIG. 3 in which the picture area is first subdivided into rows and columns of tree root blocks which are then further subdivided in accordance with a recursive multi-tree subdivisioning into one or more leaf blocks.

Again, data stream 14 may have an intra-coding mode coded thereinto for intra-coded blocks 80, which assigns one of several supported intra-coding modes to the respective intra-coded block 80. For inter-coded blocks 82, the data stream 14 may have one or more motion parameters coded thereinto. Generally speaking, inter-coded blocks 82 are not restricted to being temporally coded. Alternatively, inter-coded blocks 82 may be any block predicted from previously coded portions beyond the current picture 12 itself, such as previously coded pictures of a video to which picture 12 belongs, or picture of another view or an hierarchically lower layer in the case of encoder and decoder being scalable encoders and decoders, respectively.

The prediction residual signal 24″41 in FIG. 3 is also illustrated as a subdivision of the picture area into blocks 84. These blocks might be called transform blocks or prediction residual blocks in order to distinguish same from the coding blocks, predictor blocks or predicted blocks 80 and 82. In effect, FIG. 3 illustrates that encoder 10 and decoder 20 may use two different subdivisions of picture 12 and picture 12′, respectively, into blocks, namely one subdivisioning into coding blocks 80 and 82, respectively, and another subdivision into transform blocks 84. Both subdivisions might be the same, i.e. each coding block 80 and 82, may concurrently form a transform block 84, but FIG. 3 illustrates the case where, for instance, a subdivision into transform blocks 84 forms an extension of the subdivision into coding blocks 80, 82 so that any border between two blocks of blocks 80 and 82 overlays a border between two blocks 84, or alternatively speaking each block 80, 82 either coincides with one of the transform blocks 84 or coincides with a cluster of transform blocks 84. However, the subdivisions may also be determined or selected independent from each other so that transform blocks 84 could alternatively cross block borders between blocks 80, 82. As far as the subdivision into transform blocks 84 is concerned, similar statements are thus true as those brought forward with respect to the subdivision into blocks 80, 82, i.e. the blocks 84 may be the result of a regular subdivision of picture area into blocks (with or without arrangement into rows and columns), the result of a recursive multi-tree subdivisioning of the picture area, or a combination thereof or any other sort of blockation. Just as an aside, it is noted that blocks 80, 82 and 84 are not restricted to being of quadratic, rectangular or any other shape.

FIG. 3 further illustrates that the combination of the prediction signal 26 and the prediction residual signal 24″″ directly results in the reconstructed signal 12′. However, it should be noted that more than one prediction signal 26 may be combined with the prediction residual signal 24″″ to result into picture 12′ in accordance with alternative embodiments. Thus, a currently decoded block 18 of the picture 12′ could be reconstructed based on a prediction residual block, e.g., see 86, and a predicted block, e.g., see 80, e.g., by combining the prediction residual block and the predicted block or based on the prediction residual block, e.g., see 86, and a plurality of predicted blocks, e.g., by combining the prediction residual block and the plurality of predicted blocks.

In FIG. 3, the transform blocks 84 shall have the following significance.

Transformer 28 and inverse transformer 54 perform their transformations in units of these transform blocks 84. For instance, many codecs use some sort of DST (discrete sine transform) or DCT (discrete cosine transform) for all transform blocks 84. Some codecs allow for skipping the transformation so that, for some of the transform blocks 84, the prediction residual signal is coded in the spatial domain directly. However, in accordance with embodiments described below, encoder 10 and decoder 20 are configured in such a manner that they support several transforms. For example, the transforms supported by encoder 10 and decoder 20 could comprise:
DCT-II (or DCT-III), where DCT stands for Discrete Cosine Transform
DST-IV, where DST stands for Discrete Sine Transform
DCT-IV
DST-VII
Identity Transformation (IT)

Naturally, while transformer 28 would support all of the forward transform versions of these transforms, the decoder 20 or inverse transformer 54 would support the corresponding backward or inverse versions thereof:
Inverse DCT-II (or inverse DCT-III)
Inverse DST-IV
Inverse DCT-IV
Inverse DST-VII
Identity Transformation (IT)

In any case, it should be noted that the set of supported transforms may comprise merely one transform such as one spectral-to-spatial or spatial-to-spectral transform, but it is also possible, that no transform is used by the encoder or decoder at all or for single blocks 80, 82, 84.

As already outlined above, FIGS. 1 to 3 have been presented as an example where the inventive concept described further below may be implemented in order to form specific examples for encoders and decoders according to the present application. Insofar, the encoder and decoder of FIGS. 1 and 2, respectively, may represent possible implementations of the encoders and decoders described herein below. FIGS. 1 and 2 are, however, only examples. An encoder according to embodiments of the present application may, however, perform block-based encoding of a picture 12 using the concept outlined in more detail below and being different from the encoder of FIG. 1 such as, for instance, in that the sub-division into blocks 80 is performed in a manner different than exemplified in FIG. 3 and/or in that no transform is used at all or for single blocks. Likewise, decoders according to embodiments of the present application may perform block-based decoding of picture 12′ from data stream 14 using the coding concept further outlined below, but may differ, for instance, from the decoder 20 of FIG. 2 in that same sub-divides picture 12′ into blocks in a manner different than described with respect to FIG. 3 and/or in that same does not derive the prediction residual from the data stream 14 in transform domain, but in spatial domain, for instance and/or in that same does not use any transform at all or for single blocks. According to an embodiment the inventive concept described further below can be implemented in the residual encoding module 110 of the video encoder 10 or in the residual decoding module 210 of the video decoder 20.

For example, an embodiment is directed to a block-based predictive decoder 20 for decoding pictures 12′ from a data stream 14, wherein the block-based predictive decoder 20 is configured to derive a prediction residual block 86 of a currently decoded block 18 based on a predicted block 80 of the currently decoded block 18 (e.g., based on features extracted from the predicted block). The currently decoded block 18 can be reconstructed based on the prediction residual block 86 and the predicted block 80, e.g., by combining same as shown in FIG. 3. Alternatively, the block-based predictive decoder 20 is configured to derive a prediction residual block 86 of a currently decoded block 18 based on a plurality of predicted blocks (comprising the predicted block 80) of the currently decoded block 18 (e.g., based on features extracted from the plurality of predicted blocks) and to reconstruct the currently decoded block 18 based on the prediction residual block 86 and the plurality of predicted blocks, e.g., by combining same. A corresponding block-based predictive encoder 10 for encoding pictures 12 into a data stream 14 is configured to derive or encode a prediction residual block of a currently encoded block based on a predicted block or a plurality of predicted blocks (e.g., based on features extracted from the predicted block or the plurality of predicted blocks) of the currently encoded block so that the currently encoded block is reconstructable based on the prediction residual block and the predicted block or the plurality of predicted blocks. Details of such a block-based predictive encoder 10 and decoder 20 are described with regard to FIG. 4a to 10b, wherein the respective encoder 10 or decoder 20 may comprise features of individual Figures or a combination of features described with regard two or more of FIG. 4a to 10b.

The basic idea of this invention is to relax the constraint of separate prediction and residual coding, but to code the residual signal based on the prediction signal. Rational behind this is that there could be information in the prediction signal that allow to code the residual signal more efficiently. In particular, this invention comprises new ideas on 1) how to extract such information from the prediction signal and on 2) how to exploit this information for residual coding.

A generalized overview of this invention is depicted in FIGS. 4a and 4b. Neglecting the dashed arrow 26, FIG. 4a shows the conventional decoding process and FIG. 4b shows the conventional encoding process: Prediction signals 26 (e.g., predicted blocks) are derived by a prediction module, see 44 in FIGS. 4b and 58 in FIG. 4a, wherein the decoder 20 may use information 202 from the bitstream 14 (e.g. motion vectors or prediction modes), which information 202 may be encoded into the bitstream 14 by the corresponding encoder 10, and wherein the decoder 20 and the corresponding encoder 10 may use information from previous picture data 204 (e.g. motion-compensated blocks of previously decoded/encoded pictures or neighboring samples in a current picture).

Furthermore, a residual decoding module 210 derives the reconstructed residual signal 24″″ from the bitstream 14. Finally, the prediction signal(s) 26 and the reconstructed residual signal(s) 24″″ (e.g., the predicted block(s) of a currently decoded block and the reconstructed prediction residual block of a currently decoded block) are combined 56 (e.g. by deriving a weighted sum of the prediction signals and adding this sum to reconstructed residual signals) to obtain the reconstructed video signal 206. A corresponding encoder 10 does the opposite of the decoder 20, wherein a residual signal 24 is formed based on prediction signal(s) 26 and a video signal 106 (e.g. by deriving a weighted sum of the prediction signals 26 and subtracting 22 this sum from the video signal 106). A residual encoding module 110 encodes the residual signal 24 into the bitstream 14.

The basic idea of the invention is indicated by the dashed arrow 26: The residual decoding module 210 and the residual encoding module 110 use the one or more prediction signal(s) 26 (e.g., predicted block(s)) to decode (e.g., determine the reconstructed residual signal 24″″) or encode the residual signal (e.g., a prediction residual block), respectively.

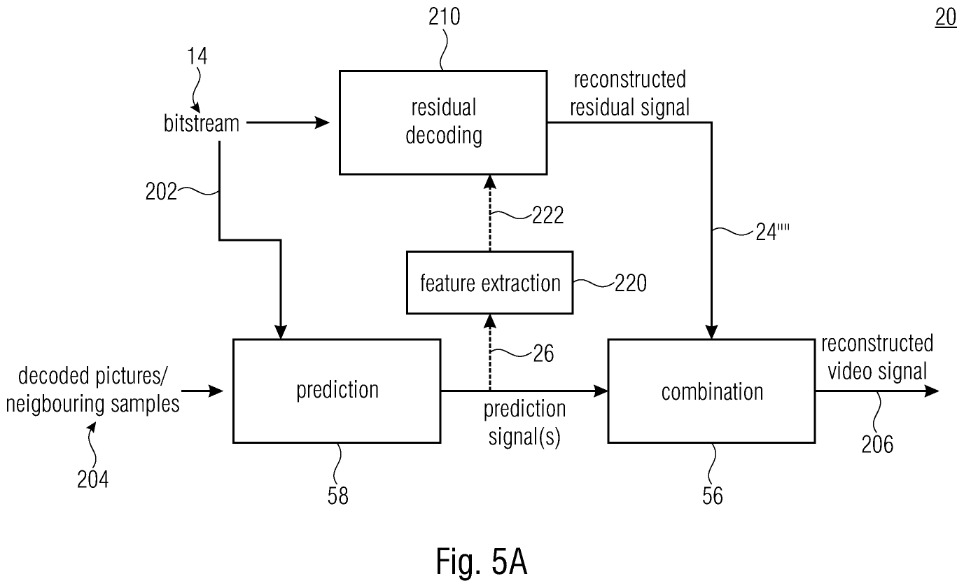

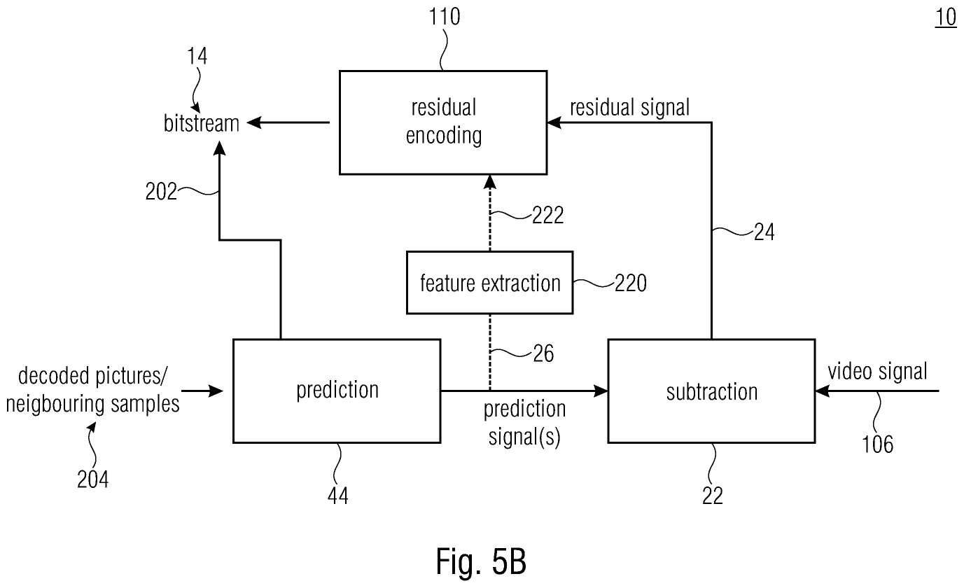

A further aspect of the invention is shown in FIGS. 5a and 5b. Here, the residual decoding module 210 or residual encoding module 110 does not use the prediction signal(s) 26 or predicted block(s) directly, but features 222 (i.e. quantified characteristics) of the prediction signal(s) 26 or predicted block(s), which are derived by a feature extraction module 220. In other words, the decoder 20 is configured to derive a prediction residual block of a currently decoded block based on a predicted block of the currently decoded block by extracting one or more features 222 from the predicted block or from the predicted blocks (e.g., in case of a plurality of predicted blocks, a feature may be extracted by comparing the plurality of predicted blocks or, for each of the plurality of predicted blocks, one or more features may be extracted), and deriving the prediction residual block of the currently decoded block based on the one or more features 222. A corresponding encoder 10 may be configured to encode a prediction residual block of a currently encoded block based on a predicted block (wherein the prediction signal 26 may comprise the predicted block or may represent the predicted block) or a plurality of predicted blocks (wherein the prediction signal 26 may comprise the plurality of predicted blocks or a plurality of prediction signals may represent the plurality of predicted blocks or the plurality of predicted blocks may be predicted from the plurality of prediction signals) of the currently encoded block by extracting one or more features 222 from the predicted block or from the plurality of predicted blocks, and encoding the prediction residual block of the currently encoded block based on the one or more features 222, e.g., the encoding performed by the residual encoding module 110 may be adapted based on the one or more features 222.

In other words, FIGS. 4a and 4b show residual decoding/encoding, see 210 and 110, and prediction, see 58 and 44, where the residual decoding/encoding depends on the prediction signals 26 (predicted blocks) directly (see the dashed arrow 26) and FIGS. 5a and 5b show residual decoding/encoding, see 210 and 110, and prediction, see 58 and 44, where the residual decoding/encoding depends on features 222 extracted from the prediction signals 26 (predicted blocks) directly. Beside this difference, the decoder 20, shown in FIG. 5a, works the same as the decoder 10 shown in FIG. 4a and the encoder 10, shown in FIG. 5b, works the same as the encoder 10 shown in FIG. 4b (as shown by the corresponding reference numerals).

The prediction module, see 58 in FIG. 4a and FIGS. 5a and 44 in FIG. 4b and FIG. 5b, may be configured to perform inter-and/or intra picture prediction.

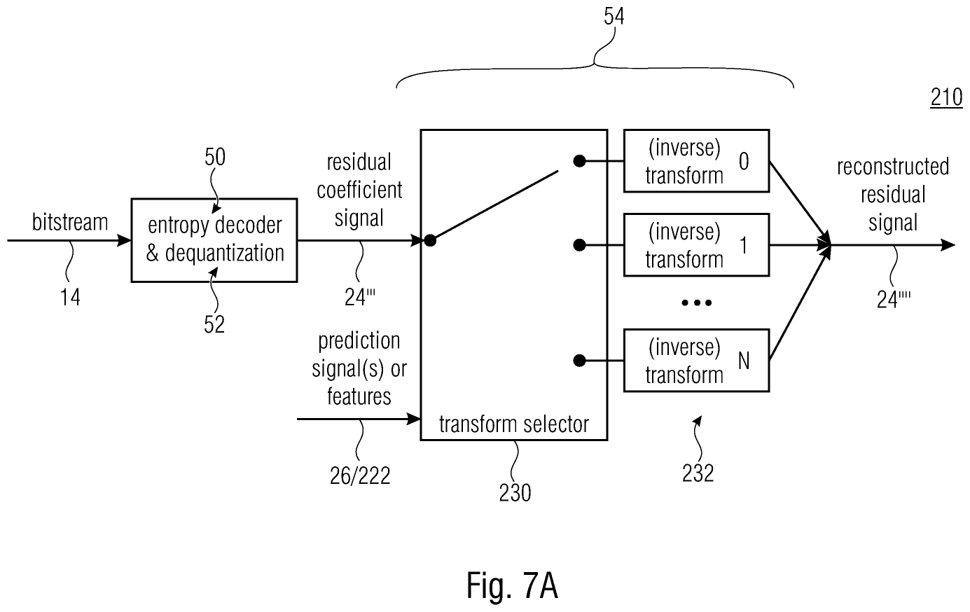

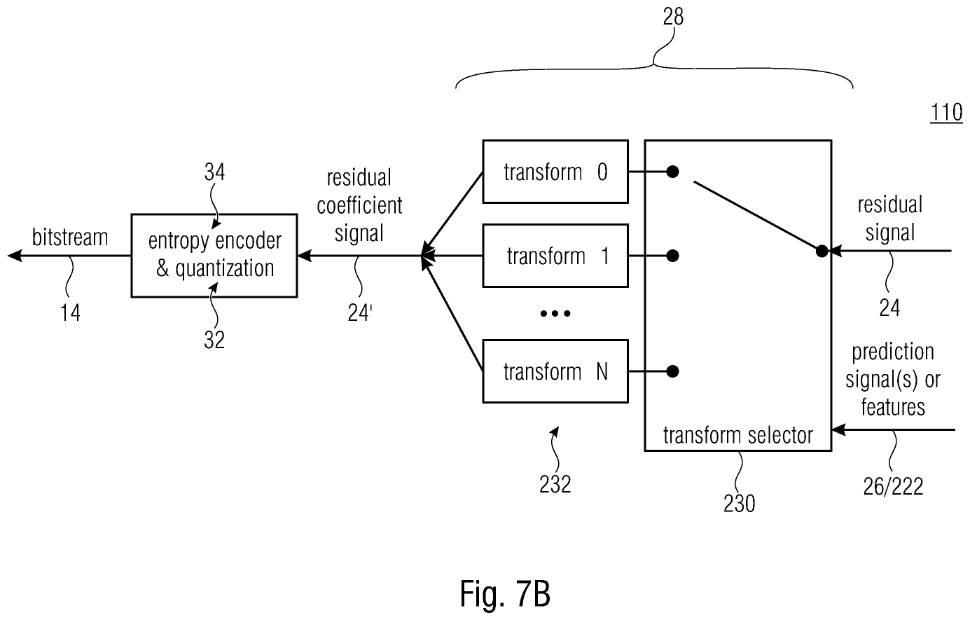

The residual decoding module 210 and the residual encoding module 110 may comprise features and/or functionalities as will be described with regard to FIG. 7a to 10b.

A first aspect of the invention concerns the operation of the residual decoding module 210 and the residual encoding module 110. In particular, in the following different modifications of the residual decoding module 210 and the residual encoding module 110 that employ the prediction signal(s) 26 (e.g., predicted block(s)) or features 222 thereof are presented.

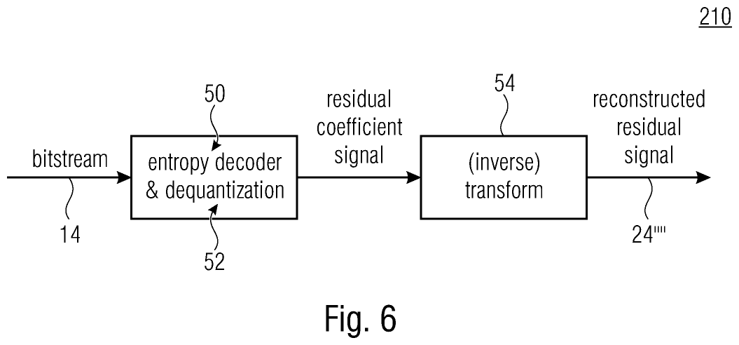

FIG. 6 shows an unmodified residual decoding module 210, similar to that employed by the most common decoders 20. An entropy decoder module 50 decodes the quantized residual signal coefficients from the bitstream 14. These coefficients are then dequantized 52 and (inverse) transformed by a transform module 54 to obtain the reconstructed residual signal 24″″, e.g., using one or more transforms. An encoder 10 does the opposite of the decoder 20, e.g., see FIG. 1, an entropy encoder module 110 applies one or more transforms (e.g., using a transform module 28) onto a prediction residual signal 24 to obtain a spectral-domain prediction residual signal 24', which is then quantized 32 and entropy encoded 34 into the bitstream 14. The present invention concerns an advantageous modification of such a residual decoding module 210 and residual encoding module 110, as will be described with regard to FIG. 7a to 10b in more detail.

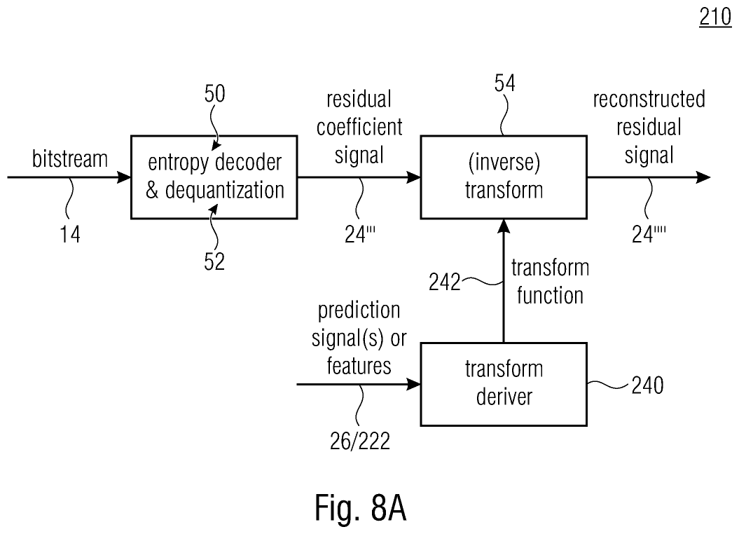

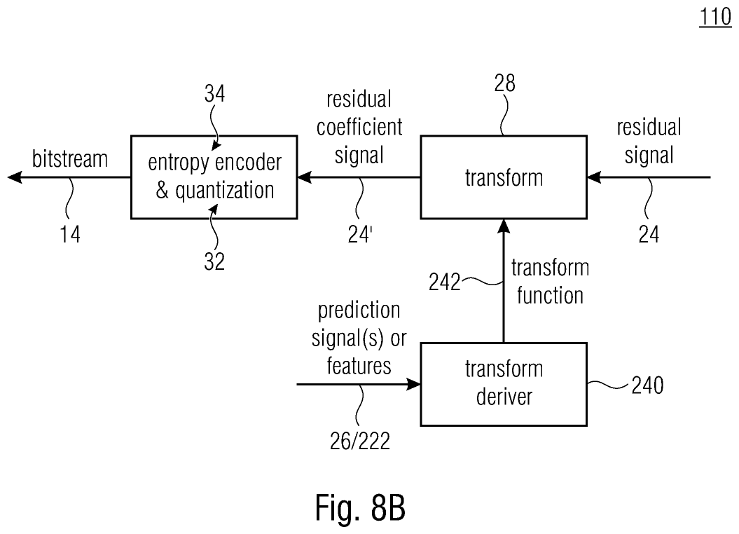

FIG. 7a to FIG. 8b show different embodiments of a residual decoding module 210 and a residual encoding module 110 with a modified transform module 54/28, which uses one or more prediction signals 26 (e.g., one or more predicted blocks) or features 222 extracted therefrom.

According to an aspect of the invention, see FIG. 7a and FIG. 7b, a transform selector module 230 uses the prediction signal(s) 26 (e.g., predicted block(s)) or features 222 derived thereof to select one (or more) of several pre-determined (inverse) transforms 232, shown in FIG. 7a and FIG. 7b as (Inverse) Transform 0, (Inverse) Transform 1, ... (Inverse) Transform N. The selected transform(s), for example, is then used to derive, at the decoder 20, the reconstructed residual signal 24″″ from the residual signal coefficients 24′″, and at the encoder 10, the spectral-domain prediction residual signal 24′ from the prediction residual signal 24.

In other words, a block-based predictive decoder 20 may be configured to derive the prediction residual block, e.g., see 86 in FIG. 3, of a currently decoded block, e.g., see 18 in FIG. 3, based on a predicted block, e.g., see 80 in FIG. 3, or a plurality of predicted blocks of the currently decoded block 18 by selecting a predetermined transformation out of a set, see 232 in FIG. 7a, of transformations based on the predicted block 80 or one or more features 222 derived therefrom or the plurality of predicted blocks or one or more features 222 derived therefrom, and decoding a transform representation, see 24″′ in FIG. 7a, from the data stream 14, and subjecting the transform representation 24″′ to a reverse transformation, e.g., inverse transformation, reversing the predetermined transformation, e.g., to obtain the prediction residual block 86 (e.g., a block of the reconstructed residual signal 24″″; or optionally the reconstructed residual signal 24″″ may represent the prediction residual block 86). A corresponding block-based predictive encoder 10 may be configured to encode a prediction residual block (e.g., a block of the residual signal 24; or optionally the residual signal 24 may represent the prediction residual block) of a currently encoded block based on a predicted block or a plurality of predicted blocks of the currently encoded block by selecting a predetermined transformation out of a set, see 232 in FIG. 7b, of transformations based on the predicted block) or one or more features 222 derived therefrom or the plurality of predicted blocks or one or more features 222 derived therefrom, subjecting the prediction residual block of the currently encoded block to the predetermined transformation to obtain a transform representation, see 24′ in FIG. 7b, and encoding the transform representation into the data stream 14, wherein the encoding of the transform representation may comprise quantizing 32 the transform representation (e.g., to obtain a quantized transform representation) and entropy encoding 24 the quantized transform representation into the data stream 14.

The pre-determined transforms 232 or some of the pre-determined transforms 232, for example, are obtained by machine learning approaches. Their number might depend on the current block size or shape, or other information available at the decoder 20 or encoder 10. In other words the transformations 232 may comprise a number of machine learned transformations, wherein the number of machine learned transformations depends on a size or shape of the currently decoded/encoded block.

In an embodiment of the invention, the transform selector 230, see FIG. 7a and FIG. 7b, could employ a neural network to select the transform, i.e. the selection may be performed by a neural network. In other words, the decoder 20/encoder 10 may be configured to select the predetermined transformation (i.e. the transformation to be used by the transform module 28 or the transformation to be reversed by the transform module 54) out of the set 232 of transformations by feeding a neural network or a predetermined function with the predicted block(s), e.g., see 80 in FIG. 3, the prediction signal(s) 26 or one or more features 222 derived from the predicted block(s) 80 or from the prediction signal(s) 26.

According to an embodiment of the invention, the transform selector 230 could select the transform depending on different pre-defined value ranges for the feature values. For example, the decoder 20/encoder 10 could be configured to select the predetermined transformation out of the set 232 of transformations by thresholding one or more features derived from the predicted block 80 or the prediction signal 16 or by comparing the one or more features to different pre-defined values or value ranges.

The selection of a transformation out of the set 232 of transformations by thresholding one or more features derived from the predicted block 80 may encompass, for each of the one or more features, to check whether a feature value of the respective feature is above or below a threshold and select a respective first transform, if the feature value is above the threshold; and select a respective second transform, if the feature value is below the threshold. The one or more features may comprise a directionality of the predicted block 80 (wherein the feature value quantifies the directionality); and/or spatial properties of the predicted block 80, like a local variance within the predicted block 80 or a magnitude of gradients of the predicted block 80; a similarity of the predicted block 80 to a pre-defined predicted block 80 (wherein the feature value quantifies the similarity); and/or properties of the predicted block 80 in a frequency space (wherein the feature value quantifies the properties).

The selection of a transformation out of the set 232 of transformations by comparing the one or more features to different pre-defined values or value ranges may comprise one or more of
comparing locations of one or more edges in the predicted block 80 with predefined locations of edges within a block;
comparing a location of (local) maxima and minima in the predicted block 80 with a predefined location of (local) maxima and minima within a block;
comparing the predicted block 80 to a pre-defined predicted block 80; and
comparing properties of the predicted block 80 in a frequency space with properties of a pre-defined block in a frequency space.

In an embodiment of the invention, a scalar directional feature is derived from a prediction signal or predicted block 80 and employed to select a transform from a set of pre-determined transforms, which, for example, have been obtained by machine learning. To derive the feature, the decoder 20/encoder 10 may first calculate the gradients of the prediction signal or predicted block. Then, the decoder 20/encoder 10 may determine a histogram of the gradient angles, where the number of bins of the histogram corresponds to the number of transforms in the set of pre-determined transforms 232. Finally, the decoder 20/encoder 10 determines the bin of the histogram with the largest number of entries, selects the pre-determined transform associated with that bin.

In another embodiment of the invention, a scalar directional feature is derived from a prediction signal or predicted block 80 and is employed to select a transform from a set of pre-determined transforms 232, which, for example, have been obtained by machine learning. To derive the feature, the decoder 20/encoder 10 first derives the gradients of the prediction signal or predicted block 80. Then, the decoder 20/encoder 10 creates a matrix from the obtained gradient vectors, which can, for example, be a covariance matrix. The decoder 20/encoder 10 then derives Eigenvectors of the matrix and their direction. Finally, the decoder 20/encoder 10 selects a pre-determined transform based on the direction.

As described above, FIG. 7a and FIG. 7b show a residual decoding/encoding using a pre-determined (inverse) transform selected based on the prediction signal 26 or its features 222 (or based on predicted block(s) or features derived therefrom).

According to another aspect of the invention, see FIG. 8a and FIG. 8b, a transform derivation module 240 uses the prediction signal(s) 26 or features 222 thereof (or the predicted block(s) or the features derived therefrom) directly to derive an arbitrary transform function (or transform) 242, which is used by the (inverse) transform module, see 54 in FIGS. 8a and 28 in FIG. 8b, to derive, at the decoder 20, the reconstructed residual signal 24″″ from the residual signal coefficients 24′″, and at the encoder 10, the spectral-domain prediction residual signal 24′ from the prediction residual signal 24. The transform derivation module 240 may be configured to derive one or more arbitrary transforms 242 based on the prediction signal(s) 26 or features 222 derived from the prediction signal(s) 26 (or based on the predicted block(s) or features derived therefrom).

In other words, the block-based predictive decoder 20 may be configured to derive the prediction residual block, e.g., see 86 in FIG. 3, of a currently decoded block, e.g., see 18 in FIG. 3, based on a predicted block, e.g., see 80 in FIG. 3, or a plurality of predicted blocks of the currently decoded block 18 by determining a reverse transformation (an example for the transform function 242 in FIG. 8a) based on the predicted block 80 (e.g., a block of the prediction signal 26) or one or more features 222 derived therefrom or based on the plurality of predicted blocks or one or more features 222 derived therefrom, decoding a transform representation, see 24″′ in FIG. 8a, from the data stream 14, and subjecting the transform representation 24″′ to the reverse transformation 242, e.g., to obtain the prediction residual block 86 (e.g., a block of the reconstructed residual signal 24″″; or optionally the reconstructed residual signal 24″″ may represent the prediction residual block 86). A corresponding block-based predictive encoder 10 may be configured to encode a prediction residual block (e.g., a block of the residual signal 24; or optionally the residual signal 24 may represent the prediction residual block) of a currently encoded block based on a predicted block (e.g., a block of the prediction signal 26) or a plurality of predicted blocks of the currently encoded block by determining a transformation 242 based on the predicted block or one or more features 222 derived therefrom or based on the plurality of predicted blocks or one or more features 222 derived therefrom, subjecting the prediction residual block of the currently encoded block to the transformation 242 to obtain a transform representation, see 24′ in FIG. 8b, and encoding the transform representation 24′ into the data stream 14, wherein the encoding of the transform representation may comprise quantizing 32 the transform representation (e.g., to obtain a quantized transform representation) and entropy encoding 24 the quantized transform representation into the data stream 14.

In an embodiment of the invention, the transform function (or transform) 242 could e.g. be determined by using the prediction signals(s) 26 or features 222 thereof (or by using the predicted block(s) or features derived therefrom) as input to a neural network (NN), i.e. the transform derivation module 240 may be configured to derive the transform 242 using a neural network. In other words, the decoder 20/encoder 10 may be configured to determine the transformation 242 based on predicted block(s) by feeding a neural network or a predetermined function with the prediction signal(s) 26, the predicted block(s), one or more features 222 derived from the predicted block(s) 80 or one or more features derived from the prediction signal(s) 26.

As described above, FIGS. 8a and 8b show a residual decoding/encoding using an (inverse) transform derived based on the prediction signal 26 or its features 222 (or based on the predicted block(s) or features derived therefrom).

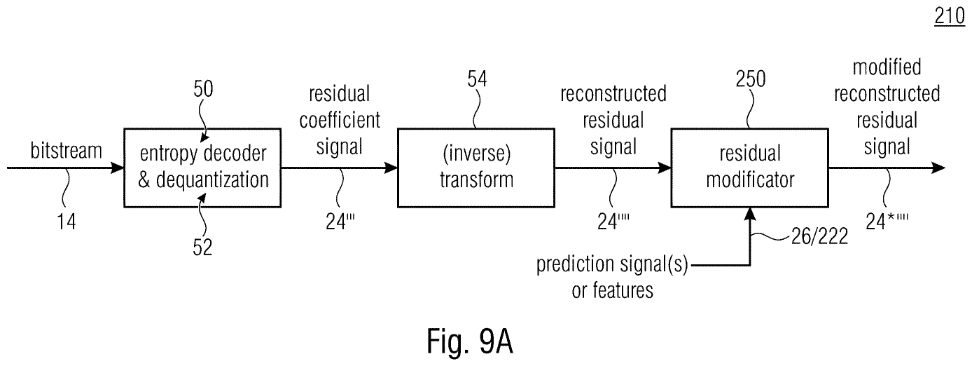

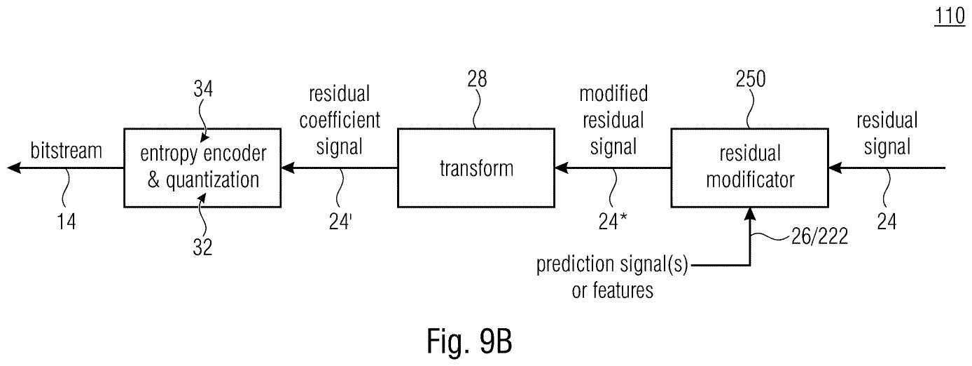

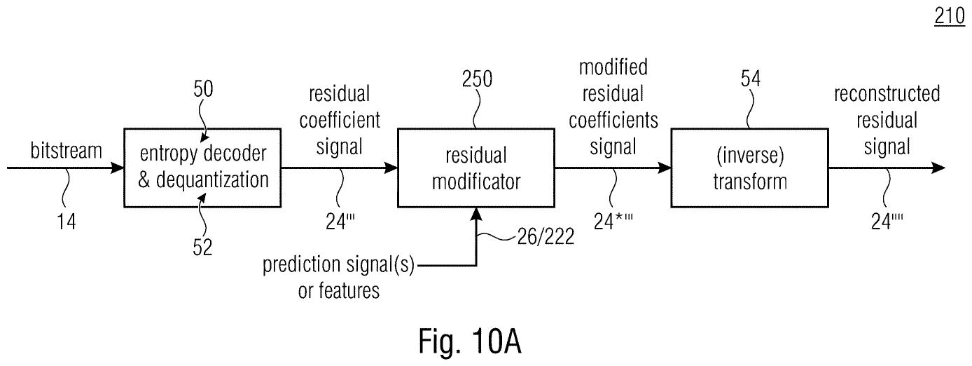

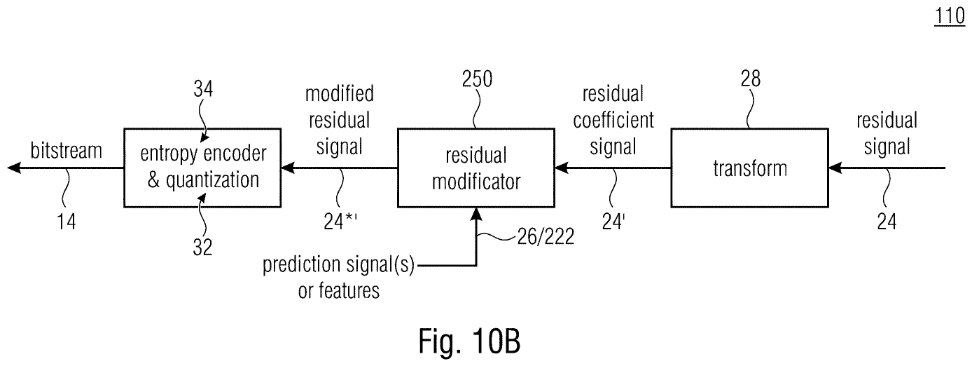

FIG. 9a to FIG. 10b show different embodiments of a residual decoding module 210 and a residual encoding module 110 with a residual modification module 250, which uses one or more prediction signals 26 (e.g., one or more predicted blocks) or features 222 extracted therefrom.

According to an aspect of the invention, see FIG. 9a and FIG. 9b, a residual modification module 250 uses the prediction signal(s) 26 or features 222 thereof to modify, at the decoder 20, the reconstructed residual signal 24″″ and so to derive a modified reconstructed residual signal 24*″″ (e.g., when combining the reconstructed residual signal and the one or more prediction signals 26, the modified reconstructed residual signal 24*″″ forms the reconstructed residual signal), and the encoder 10, the residual signal 24 to obtain a modified residual signal 24*. The decoder 20, for example, is configured to modify the residual signal, see the reconstructed residual signal 24″″, after the transform 54 based on the prediction signal(s) 26 or features 222 of the prediction signal(s) 26.

In other words, a block-based predictive decoder 20 may be configured to derive the prediction residual block, e.g., see 86 in FIG. 3, of a currently decoded block, e.g., see 18 in FIG. 3, based on a predicted block, e.g., see 80 in FIG. 3, or a plurality of predicted blocks of the currently decoded block 18 by decoding a transform representation 24″′ from the data stream 14, subjecting the transform representation 24″′ to a reverse transformation 54 (e.g., an inverse transformation, reversing a transformation applied by an encoder 10) to obtain a retransformed block (e.g., a block of the reconstructed residual signal 24″″; or optionally the reconstructed residual signal 24″″ may represent the retransformed block), and forming the prediction residual block (e.g., see 86 in FIG. 3; e.g., a block of a modified reconstructed residual signal 24*″″) of the currently decoded block based on the retransformed block depending on the predicted block 80 or one or more features 222 derived therefrom or the plurality of predicted blocks or one or more features 222 derived therefrom (e.g., modifying the retransformed block depending on the prediction signal 26 or one or more features 222 derived therefrom to obtain the prediction residual block). A corresponding block-based predictive encoder 10 may be configured to encode a prediction residual block (e.g., a block of the residual signal 24; or optionally the residual signal 24 may represent the prediction residual block) of a currently encoded block based on a predicted block (wherein the prediction signal 26 may comprise the predicted block or may represent the predicted block) or a plurality of predicted blocks of the currently encoded block by forming the prediction residual block (e.g., a block of a modified residual signal 24*; or optionally the modified residual signal 24* may represent the prediction residual block) of the currently encoded block depending on the predicted block or one or more features 222 derived therefrom or the plurality of predicted blocks or one or more features 222 derived therefrom, subjecting the prediction residual block of the currently encoded block to a transformation 28 to obtain a transform representation, see 24′ in FIG. 9b, and encoding the transform representation into the data stream 14, wherein the encoding of the transform representation may comprise quantizing 32 the transform representation (e.g., to obtain a quantized transform representation) and entropy encoding 24 the quantized transform representation into the data stream 14.

In an embodiment of the invention, the modification, see 250, could include, at the decoder 20, setting parts of the reconstructed residual signal 24″″ (e.g., of the reconstructed prediction residual block) to zero or to a predetermined value, and at the encoder 10, setting parts of the residual signal 24 (e.g., of the prediction residual block) to zero or to a predetermined value. In another embodiment of the invention, the modification, see 250, could include, at the decoder 20, cropping the reconstructed residual signal 24″″ (e.g., the reconstructed prediction residual block) or shifting it relative to the prediction signal 26 (e.g., the predicted block) based on the prediction signal(s) 26 or features 222 thereof (or based on the predicted block(s) or features derived therefrom), and at the encoder 10, cropping the residual signal 24 (e.g., the prediction residual block) or shifting it relative to the prediction signal 26 (e.g., the predicted block) based on the prediction signal(s) 26 or features 222 thereof (or based on the predicted block(s) or features derived therefrom). In another embodiment of the invention, the modification, see 250, could include, at the decoder 20, shifting the reconstructed residual signal 24″″ to a specific pre-determined block partition of the prediction signal 26 (e.g., to a location of a specific partition of the prediction signal(s), e.g., before adding, see 56 in FIG. 2, FIG. 4a and FIG. 5a) based on the prediction signal(s) 26 or features 222 thereof, and at the encoder 10, shifting the residual signal 24 to a specific pre-determined block partition of the prediction signal 26 based on the prediction signal(s) 26 or features 222 thereof. In another embodiment of the invention, the modification, see 250, could include, at the decoder 20, reordering the samples of the reconstructed residual signal 24″″ (e.g., of the reconstructed prediction residual block) based on the prediction signal(s) 26 or features 222 thereof (or based on the predicted block(s) or features derived therefrom), and at the encoder 10, reordering the samples of the residual signal 24 (e.g., of the prediction residual block) based on the prediction signal(s) 26 or features 222 thereof (or based on the predicted block(s) or features derived therefrom). In another embodiment of the invention, the modification, see 250, could be applied by a neural network based on the prediction signal(s) 26 or features 222 thereof (or based on the predicted block(s) or features derived therefrom). In another embodiment of the invention, the modification, see 250, could be applied by a filter based on or derived from the prediction signal(s) 26 or features 222 thereof (or derived from the predicted block(s) or from features derived from the predicted block(s)).

In other words, a block-based predictive decoder 20/encoder 10 may be configured to form the prediction residual block (e.g., a modified prediction residual block; e.g., for the decoder 20, a block of the modified reconstructed residual signal 24*″″ (or the modified reconstructed residual signal 24*″″ represents the prediction residual block); e.g., for the encoder 10, a block of the modified residual signal 24* (or the modified residual signal 24* represents the prediction residual block)) of the currently decoded/encoded block depending on the predicted block (wherein the prediction signal 26 may comprise the predicted block or may represent the predicted block) or one or more features derived therefrom or the plurality of predicted blocks or one or more features 222 derived therefrom [e.g., based on, at the decoder side, the retransformed block (e.g., a block of the reconstructed residual signal 24″″; or optionally the reconstructed residual signal 24″″ may represent the retransformed block), and at the encoder side, an unmodified prediction residual block (e.g., a block of the residual signal 24; or optionally the residual signal 24 may represent the unmodified prediction residual block)] by one or more of

Setting the prediction residual block in one or more sample portions to a predetermined value such as zero, which one or more portions are positioned depending on the predicted block or one or more features derived therefrom or depending on the plurality of predicted blocks or one or more features 222 derived therefrom,
cropping and/or shifting the retransformed block (at the decoder side) or the unmodified prediction residual block (at the encoder side) in a manner depending on the predicted block or one or more features derived therefrom or depending on the plurality of predicted blocks or one or more features 222 derived therefrom,
(at the decoder side) placing the retransformed block at a position within the prediction residual block which depends on the predicted block or one or more features derived therefrom or on the plurality of predicted blocks or one or more features 222 derived therefrom, or (at the encoder side) placing the unmodified prediction residual block at a position within the prediction residual block which depends on the predicted block or one or more features derived therefrom or on the plurality of predicted blocks or one or more features 222 derived therefrom,
placing samples of the retransformed block (at the decoder side) or the unmodified prediction residual block (at the encoder side) within the prediction residual block at a relative spatial arrangement which depends on the predicted block or one or more features derived therefrom or on the plurality of predicted blocks or one or more features 222 derived therefrom,
filtering the retransformed block (at the decoder side) or the unmodified prediction residual block (at the encoder side) by a filter parametrized depending on the predicted block or one or more features derived therefrom or depending on the plurality of predicted blocks or one or more features 222 derived therefrom,
subjecting the retransformed block (at the decoder side) or the unmodified prediction residual block (at the encoder side) to a neural network dependent on the predicted block or one or more features derived therefrom or dependent on the plurality of predicted blocks or one or more features 222 derived therefrom,
subjecting the retransformed block (at the decoder side) or the unmodified prediction residual block (at the encoder side) and the predicted block or one or more features derived therefrom (or the plurality of predicted blocks or one or more features 222 derived therefrom) to a neural network.

As described above, FIGS. 9a and 9b show a residual decoding/encoding with modification, see 250, of the reconstructed residual signal/residual signal (e.g., reconstructed prediction residual block/prediction residual block) based on the prediction signal 26 or its features 222 (or based on the predicted block(s) or features derived therefrom).

According to another aspect of the invention, see FIG. 10a, a residual modification module 250 uses the prediction signal(s) 26 or features 222 thereof to modify the residual coefficients signal 24″′ and to derive modified residual signal coefficients 24*″′ which are then (inverse) transformed 54 to obtain the reconstructed residual signal 24″′. FIG. 10 shows this aspect for a corresponding encoder 10, which is configured to transform a prediction residual signal 24 to obtain a spectral-domain prediction residual signal 24′ and modify the spectral-domain prediction residual signal 24′ to obtain a modified spectral-domain prediction residual signal 24*′ (e.g., using the residual modification module 250). The decoder 20, for example, is configured to modify the residual coefficient signal 24″′ before the transform 54 based on the prediction signal(s) 26 or features 222 of the prediction signal(s) 26.

In other words, a block-based predictive decoder 20 may be configured to derive the prediction residual block, e.g., see 86 in FIG. 3, of a currently decoded block, e.g., see 18 in FIG. 3, based on a predicted block, e.g., see 80 in FIG. 3, or a plurality of predicted blocks of the currently decoded block 18 or based on one or more features derived from the predicted block or the plurality of predicted blocks by decoding a transform representation 24″′ from the data stream 14, modifying the transform representation 24″′ depending on the predicted block or one or more features derived therefrom (or depending on the plurality of predicted blocks or one or more features 222 derived therefrom) to obtain a modified transform representation 24*′″, and subjecting the modified transform representation 24*″′ to a reverse transformation 54 (e.g., an inverse transformation, reversing a transformation applied by an encoder 10). A corresponding block-based predictive encoder 10 may be configured to encode a prediction residual block (e.g., a block of the residual signal 24; or optionally the residual signal 24 may represent the prediction residual block) of a currently encoded block based on a predicted block (wherein the prediction signal 26 may comprise the predicted block or may represent the predicted block) or a plurality of predicted blocks of the currently encoded block by subjecting the prediction residual block to a transformation 28 to obtain a transform representation, e.g., a spectral-domain prediction residual signal 24′, modifying the transform representation depending on the predicted block or one or more features 222 derived therefrom (or depending on the plurality of predicted blocks or one or more features 222 derived therefrom) to obtain a modified transform representation 24*′, and encoding the modified transform representation 24*′ into the data stream 14, wherein the encoding of the modified transform representation 24*′ may comprise quantizing 32 the modified transform representation 24*′ (e.g., to obtain a quantized transform representation) and entropy encoding 24 the quantized transform representation into the data stream 14.

In an embodiment of the invention, the modification, see 250, could include setting a subset of residual signal coefficients (e.g., for the decoder 20, of a transform representation 24′″; e.g., for the encoder 10, of a spectral-domain prediction residual signal 24′) to zero or to a predetermined value based on the prediction signal(s) 26 or features 222 thereof (or based on predicted block(s) or one or more features 222 derived therefrom). In another embodiment of the invention, the modification, see 250, could include applying a second transform to the residual signal coefficients (e.g., for the decoder 20, of a transform representation 24″′; e.g., for the encoder 10, of a spectral-domain prediction residual signal 24′) based on the prediction signal(s) 26 or features 222 thereof (or based on predicted block(s) or one or more features 222 derived therefrom). In another embodiment of the invention, the modification, see 250, could be applied by a neural network based on the prediction signal(s) 26 or features 222 thereof (or based on predicted block(s) or one or more features 222 derived therefrom).

In other words, a block-based predictive decoder 20/encoder 10 may be configured to modify the transform representation 24″′/24′ depending on the predicted block (wherein the prediction signal 26 may comprise the predicted block or may represent the predicted block) or one or more features 222 derived therefrom (or depending on the plurality of predicted blocks or one or more features 222 derived therefrom) by one or more of
setting a subset of coefficients of the transform representation 24″′/24′ to a predetermined value such as zero, which one or more coefficients or predetermined values are identified depending on the predicted block or one or more features 222 derived therefrom (or depending on the plurality of predicted blocks or one or more features 222 derived therefrom),
applying a secondary transform to the transform representation 24″′/24′ depending on the predicted block or one or more features 222 derived therefrom (or depending on the plurality of predicted blocks or one or more features 222 derived therefrom),
applying a neural network to the transform representation 24″′/24′ depending on the predicted block or one or more features 222 derived therefrom (or depending on the plurality of predicted blocks or one or more features 222 derived therefrom).

As described above, FIGS. 10a and 10b show a residual decoding/encoding with modification, see 250, of the residual signal coefficients, see 24′″/24′, based on the prediction signal 26 or its features 222 (or based on predicted block(s) or one or more features 222 derived therefrom).

Additionally, or alternatively to the above described aspects, it is possible to select a sub-partition of a block based on the prediction signal(s) 26 or features 222 thereof (or based on predicted block(s) or one or more features 222 derived therefrom) and to add the reconstructed residual signal 24″″ (e.g., a reconstructed prediction residual block) to the selected sub-partition. In other words, a sub-partition of a block is selected based on the prediction signal(s) 26 or features 222 thereof and the reconstructed residual signal 24″″ is used to reconstruct the picture/video signal of the selected sub-partition. In other words, a block-based predictive decoder 20/encoder 10 may be configured to select a sub-partition of a currently decoded/encoded block based on the predicted block(s) of the currently decoded block or features 222 derived from the predicted block(s) and reconstruct the sub-partition of the currently decoded/encoded block using the prediction residual block.

For example, it is possible that a herein described decoder 20/encoder 10 performs a partition selection based on a local difference of prediction signals or of predicted blocks. In an embodiment of the invention, a sub-block (or sub-area or sub-partition) is selected from a set of sub-blocks (or sub-areas or sub-partitions) formed by a partitioning of a current block. For this, the decoder 20/encoder 10 may be configured to derive a feature value to each of the sub-blocks (or sub-areas) of the current block, i.e. a feature value is derived per sub-partition. Given a current sub-block (or sub-area or sub-partition), this may be done by summing up the squared differences of two prediction signals 26 (e.g., two predicted blocks; e.g., obtained by B prediction) within the current sub-bock (or sub-area or sub-partition). The decoder 20/encoder 10 may select the sub-block (or sub-area or sub-partition) with highest feature value. Finally, the decoder 20/encoder 10 may be configured to shift the decoded/encoded residual signal to the selected sub-block and/or uses it for reconstruction of the video signal within that block.

In an embodiment of the invention, the sub-partitions are rectangular blocks.

The herein described embodiments, see FIGS. 4a to 10b, are based on the idea that one or more prediction signals 26 or features 222 derived therefrom (or one or more predicted blocks or one or more features 222 derived therefrom) can be used to improve a decoding/encoding of a residual signal (e.g., a prediction residual block). This section discusses the aspects of the invention concerning the operation of the feature extraction module 220, see FIG. 5a and FIG. 5b. In particular, it presents different methods to derive features 222 from the prediction signal(s) 26 or predicted block(s). The features 222 can then be used by the modified residual decoding module 210 and modified residual encoding module 110 described with regard to FIGS. 7a to 10b.

An aspect of the invention is to derive features 222 quantifying the directionality of the one or more prediction signals 26 or predicted block(s). In an embodiment of the invention, the directionality could be determined from the gradients of the prediction signals 26 or predicted block(s). In another embodiment of the invention, the directionality could be determined from a histogram of the gradients angles of the prediction signals(s) 26 or predicted block(s). In another embodiment of the invention, the directionality could be determined from the Eigenvalues and/or Eigenvectors of a matrix derived from the gradients.

Another aspect of the invention is to derive features 222 quantifying the spatial properties of the one or more prediction signals 26 or one or more predicted blocks. In an embodiment of the invention, a spatial property could be the local variance within the prediction signals 26 or predicted block(s). In another embodiment of the invention, a spatial property could be the magnitude of the gradients of the prediction signal(s) 26 or of the predicted block(s). In another embodiment of the invention, a spatial property could be the location of edges in the prediction signal(s) 26 or in the predicted block(s). In another embodiment of the invention, a spatial property could be the location of (local) maxima and minima in the prediction signal(s) 26 or in the predicted block(s).

Another aspect of the invention is to derive features 222 quantifying the similarity of one or more prediction signals 26 or of one or more predicted block(s) to particular pre-defined signals.

Another aspect of the invention is to derive features 222 quantifying the properties of prediction signal(s) 26 or of predicted block(s)in a frequency space.

Another aspect of the invention is to derive features 222 from one or more prediction signals 26 (e.g., from the one or more predicted blocks) by using a neural network, e.g., by feeding the prediction block (predicted block) or predicted blocks or one or more prediction signals 26 to the neural network.

Another aspect of the invention is to compare the prediction signals 26 or predicted block(s) to each other and derive features 222 thereof.

In an embodiment of the invention the squared difference of the prediction signals 26 or predicted block(s) is derived as feature 222.

Another aspect of the invention is to combine the prediction signals 26 or predicted block(s) and derive features 222 thereof.

Another aspect of the invention is to derive features 222 for the prediction signals 26 or predicted blocks individually, and then to combine the features 222.

Another aspect of the invention derives a feature map comprising local features 222 of the prediction signal(s) 26 (e.g., predicted block(s)). The feature map may define a mapping of its values to locations in the prediction block(s) (predicted block(s)) or prediction signal(s) 26.

Another aspect of the invention derives feature values of the prediction signal 26 or the predicted block (e.g., herein also understood as prediction block) individually for different rectangular sub-blocks of a block or different sub-areas of an area.

Another aspect of the invention derives a feature vector comprising different features 222 of the prediction signal(s) 26 or the predicted block(s).

Summarizing the one or more features 222 include one or more of
A directionality measure of the predicted block or of two or more predicted blocks, e.g., for each of the two or more predicted blocks, a respective directionality measure,
Data derived from gradients of the predicted block or of two or more predicted blocks, e.g., for each of the two or more predicted blocks, data derived from gradients of the respective predicted block,
Data (e.g., information associated with a bin having the largest number of entries) derived from a histogram of gradient angels of the predicted block or of two or more predicted blocks, e.g., for each of the two or more predicted blocks, data derived from a histogram of gradient angels of the respective predicted block,
Data derived from Eigenvalues and/or Eigenvectors of a matrix, e.g., a covariance matrix, derived from gradient angels of the predicted block or of two or more predicted blocks, e.g., for each of the two or more predicted blocks, data derived from Eigenvalues and/or Eigenvectors of a matrix, e.g., a covariance matrix, derived from gradient angels of the respective predicted block,
A spatial measure of the predicted block or of two or more predicted blocks, e.g., for each of the two or more predicted blocks, a respective spatial measure,
A map of local variances of the predicted block or of two or more predicted blocks, e.g., for each of the two or more predicted blocks, a map of local variances of the respective predicted block,
A magnitude of gradients of the predicted block or of two or more predicted blocks, e.g., for each of the two or more predicted blocks, a magnitude of gradients of the respective predicted block,
The location of the maxima and minima in the predicted block or in two or more predicted blocks, e.g., for each of the two or more predicted blocks, a location of the maxima and minima in the respective predicted block,
The positions of edges in the predicted block or in two or more predicted blocks, e.g., for each of the two or more predicted blocks, positions of edges in the respective predicted block,
A similarity of the predicted block or of the predicted blocks of two or more predicted blocks to one or more pre-defined block templates, e.g., for each of the two or more predicted blocks, a similarity of the respective predicted block to one or more pre-defined block templates.

According to an embodiment, the one or more features 222 may include (additionally or alternatively) one or more of
A similarity measure of (or between) the two or more predicted blocks,
A measure, e.g., a squared difference of the two or more predicted blocks, derived by comparing the two or more predicted blocks,
A measure derived from the combination of the two or more predicted blocks,
A measure derived by first deriving individual measures for the predicted blocks of the two or more predicted blocks and then combining the individual measures (the individual measures may comprise one or more of the above described one or more features).

In case the predicted block is predicted from two or more prediction signals 26, the one or more features 222 may include one or more of
A similarity measure of (or between) the prediction signals 26,
A measure, e.g., a squared difference of the prediction signals 26, derived by comparing the prediction signals 26,
A measure derived from the combination of the prediction signals 26,
A measure derived by first deriving individual measures for the prediction signals 26 and then combining the individual measures (the individual measures may comprise one or more of the above described one or more features).

According to an embodiment, the features 222 are derived in a frequency space.

According to an embodiment the prediction block (e.g., the predicted block) is derived from reconstructed samples of spatial neighboring areas of the predicted block. For example, the prediction signal 26 or predicted block is derived from reconstructed samples of spatial neighboring areas of the current area (e.g., a current block or a currently decoded/encoded block).

As described herein, the residual signal (e.g., a prediction residual block) and the prediction signals 26 (or predicted blocks) may be related to a current area (e.g., a current block or a currently decoded/encoded block) in a (reconstructed) picture.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus. Analogously, an apparatus may comprise a hardware apparatus, like for example, a microprocessor, a programmable computer or an electronic circuit, configured to perform one or more method steps.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

The inventive encoded picture or video signal can be stored on a digital storage medium or can be transmitted on a transmission medium such as a wireless transmission medium or a wired transmission medium such as the Internet.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A video decoder configured to derive one or more prediction signals; reconstructing a residual signal from a bitstream; and combining the reconstructed residual signal and the one or more prediction signals, in which the reconstruction of the residual signal depends on the one or more prediction signals.

2. Video decoder according to claim 1, wherein the decoder applies inter-and/or intra picture prediction.

3. Video decoder according to claim 1, wherein the decoder applies one or more transforms to a residual coefficient signal when reconstructing the residual signal.

4. Video decoder according to claim 3, wherein the decoder selects one or more transforms from a predetermined set of transforms based on the prediction signals or features derived from the prediction signals.

5. Video decoder according to claim 4, wherein the pre-determined set of transforms is derived by a machine learning approach.

6. Video decoder according to claim 4, wherein the selection is performed by a neural network.

7. Video decoder according to claim 4, wherein the selection is performed by comparing feature values to different pre-defined values or different pre-defined value ranges.

8. Video decoder according to claim 3, wherein the decoder derives one or more arbitrary transforms based on the prediction signals or features derived from the prediction signals.

9. Video decoder according to claim 8, wherein the decoder derives the transforms with a neural network.

10. Video decoder according to claim 3, wherein the decoder modifies the residual signal after the transform based on the prediction signals or features of the prediction signals.

11. Video decoder according to claim 10, wherein the modification includes setting parts of the residual signal to zero or to other pre-determined values.

12. Video decoder according to claim 10, wherein the modification includes shifting the residual signal to the location of a specific partition of the prediction signals before adding.

13. Video decoder according to claim 10, wherein the modification includes reordering the samples of the residual signal.

14. Video decoder according to claim 10, wherein the modification includes cropping the residual signal.

15. Video decoder according to claim 10, wherein the modification includes applying a filter to the residual signal.

16. Video decoder according to claim 3, wherein the decoder modifies the residual coefficient signal before the transform based on the prediction signals or features of the prediction signals.

17. Video decoder according to claim 16, wherein the modification includes setting parts of the residual coefficients signal to zero or to another pre-determined values.

18. Video decoder according to claim 16, wherein the modification includes applying a second transform to the residual coefficient signal.

19. Video decoder according to claim 16, wherein the modification includes applying a neural network.

20. Video decoder according to claim 3, wherein a sub-partition of a block is selected based on the prediction signal(s) or features thereof and the reconstructed residual signal is used to reconstruct the video signal of the selected sub-partition.

21. Video decoder according to claim 20, wherein a feature value is derived per sub-partition.

22. Video decoder according to claim 20, wherein the sub-partition with the highest or lowest feature value is selected.

23. Video decoder according to claim 20, wherein the sub-partitions are rectangular blocks.

24. Video decoder according to claim 4, wherein the features derived from the prediction signal(s) quantify the directionality of the prediction signals.

25. Video decoder according to claim 24, wherein the features are derived from the gradients of the prediction signal(s).

26. Video decoder according to claim 24, wherein the features are derived from a histogram of the gradients angles of the prediction signals.

27. Video decoder according to claim 24, wherein the features are derived from the Eigenvalues and/or Eigenvectors of a matrix derived from the gradients.

28. Video decoder according to claim 4, wherein the features derived from the prediction signals quantify spatial features of the prediction signals.

29. Video decoder according to claim 28, wherein the spatial features represent the local variance in the prediction signals.

30. Video decoder according to claim 28, wherein the spatial features represent the location of edges within the prediction signals.

31. Video decoder according to claim 28, wherein the spatial features represent the magnitude of the gradients of the prediction signal(s).

32. Video decoder according to claim 28, wherein the spatial features represent the location of (local) maxima and minima in the prediction signal(s).

33. Video decoder according to claim 4, wherein the prediction signals are compared to each other to derive the features.

34. Video decoder according to claim 33, wherein the comparison derives the squared difference of the prediction signals.

35. Video decoder according to claim 4, wherein the prediction signals are combined to derive the features.

36. Video decoder according to claim 24, wherein features are derived individually for each prediction and then the features are combined.

37. Video decoder according to claim 4, wherein the features quantify the similarity of one or more prediction signals to particular pre-defined signals.

38. Video decoder according to claim 4, wherein the features quantify the properties of prediction signals in a frequency space.

39. Video decoder according to claim 4, wherein features are derived by a neural network.

40. Video decoder according to claim 4, wherein the features are a feature map that defines a mapping of its values to locations in the prediction signal(s).

41. Video decoder according to claim 4, wherein feature values of the prediction signal(s) are individually derived for different rectangular sub-blocks of a block or for different sub-areas of an area.

42. Video decoder according to claim 4, wherein the features are a vector comprising different features of the prediction signal(s).

43. Video decoder according to claim 1, wherein the residual signal and the prediction signals are related to a current area in a reconstructed picture.

44. Video decoder according to claim 43, wherein the prediction signal is derived from reconstructed samples of spatial neighboring areas of the current area.

45. Block-based predictive decoder for decoding pictures from a data stream configured to
Derive a prediction residual block of a currently decoded block based on a predicted block of the currently decoded block, and
Reconstruct the currently decoded block based on the prediction residual block and the predicted block.

46. Block-based predictive decoder of claim 45, configured to derive the prediction residual block of the currently decoded block based on the predicted block of the currently decoded block by
Extracting one or more features from the predicted block, and
Deriving the prediction residual block of the currently decoded block based on the one or more features.

47. Block-based predictive decoder of claim 45, configured to derive the prediction residual block of the currently decoded block based on the predicted block of the currently decoded block by
Selecting a predetermined transformation out of a set of transformations based on a prediction signal or one or more features derived therefrom, and
Decoding a transform representation from the data stream,
Subjecting the transform representation to a reverse transformation reversing the predetermined transformation.

48. Block-based predictive decoder of claim 47, wherein the transformations comprise a number of machine learned transformations.

49. Block-based predictive decoder of claim 48, wherein the number of machine learned transformations depends on a size or shape of the currently decoded block.

50. Block-based predictive decoder of claim 47, configured to selecting the predetermined transformation out of the set of transformations by feeding a neural network or a predetermined function with the predicted block or one or more features derived from the predicted block.

51. Block-based predictive decoder of claim 47, configured to selecting the predetermined transformation out of the set of transformations by thresholding one or more features derived from the predicted block or by comparing them to different pre-defined values or value ranges.

52. Block-based predictive decoder of claim 45, configured to derive the prediction residual block of the currently decoded block based on the predicted block of the currently decoded block by
Determining a reverse transformation based on the predicted block or one or more features derived therefrom, and
Decoding a transform representation from the data stream,
Subjecting the transform representation to the reverse transformation.

53. Block-based predictive decoder of claim 52, configured to determine the reverse transformation based on the predicted block by feeding a neural network or a predetermined function with a prediction signal or one or more features derived from the predicted block or one or more features derived therefrom.

54. Block-based predictive decoder of claim 45, configured to derive the prediction residual block of the currently decoded block based on the predicted block of the currently decoded block by
Decoding a transform representation from the data stream,
Subjecting the transform representation to a reverse transformation to obtain a retransformed block, and
Forming the prediction residual block of the currently decoded block based on the retransformed block depending on a prediction signal or one or more features derived therefrom.

55. Block-based predictive decoder of claim 54, configured to form the prediction residual block of the currently decoded block based on the retransformed block depending on the predicted block by one or more of
Setting the prediction residual block in one or more sample portions to a predetermined value such as zero, which one or more portions are positioned depending on the predicted block or one or more features derived therefrom,
cropping and/or shifting the retransformed block in a manner depending on the predicted block or one or more features derived therefrom,
placing the retransformed block at a position within the prediction residual block which depends on the predicted block or one or more features derived therefrom,
placing samples of the retransformed block within the prediction residual block at a relative spatial arrangement which depends on the predicted block or one or more features derived therefrom,
filtering the retransformed block by a filter parametrized depending on the predicted block or one or more features derived therefrom,
subjecting the retransformed block to a neural network dependent on the predicted block or one or more features derived therefrom,
subjecting the retransformed block and the predicted block or one or more features derived therefrom to a neural network.

56. Block-based predictive decoder of claim 45, configured to derive the prediction residual block of the currently decoded block based on the predicted block of the currently decoded block by
Decoding a transform representation from the data stream,
Modifying the transform representation depending on the predicted block or one or more features derived therefrom to obtain a modified transform representation,
Subjecting the modified transform representation to a reverse transformation.

57. Block-based predictive decoder of claim 56, configured to modify the transform representation depending on the predicted block by one or more of
Setting a subset of coefficients of the transform representation to a predetermined value such as zero, which one or more coefficients or predetermined values are identified depending on the predicted block,
Applying a secondary transform to the transform representation depending on the predicted block,
Applying a neural network to the transform representation depending on the predicted block.

58. Block-based predictive decoder of claim 45, configured to select a sub-partition of the currently decoded block based on the predicted block of the currently decoded block or based on one or more features derived from the predicted block using the prediction residual block for reconstruction of the sub-partition of the currently decoded block.

59. Block-based predictive decoder of claim 58, configured to derive a feature value per sub-partition of currently decoded block.

60. Block-based predictive decoder of claim 59, configured to select the sub-partition with highest or lowest feature value.

61. Block-based predictive decoder of claim 60 wherein the sub-partition are rectangular blocks.

62. Block-based predictive decoder of claim 45, wherein the one or more features include one or more of
A directionality measure of the predicted block,
Data derived from gradients of the predicted block,
Data derived from a histogram of gradient angels of the predicted block,
Data derived from Eigenvalues and/or Eigenvectors of a matrix, e.g., a covariance matrix, derived from gradient angels of the predicted block,
A spatial measure of the predicted block,
A map of local variances of the predicted block,
A magnitude of gradients of the predicted block,
The location of the maxima and minima in the predicted block,
The positions of edges in the predicted block,
A similarity of the predicted block to one or more pre-defined block templates.

63. Block-based predictive decoder of claim 45, wherein the predicted block is predicted from two or more prediction signals and the one or more features include one or more of
A similarity measure of the prediction signals,
A measure, e.g., a squared difference of the prediction signals, derived by comparing the prediction signals,
A measure derived from the combination of the prediction signals,
A measure derived by first deriving individual measures for the prediction signals and then combining the individual measures.

64. Block-based predictive decoder of claim 45, configured to
derive a plurality of predicted blocks comprising the predicted block for the currently decoded block,
derive the prediction residual block of the currently decoded block based on the predicted block; and
reconstruct the currently decoded block based on the prediction residual block and the plurality of predicted blocks.

65. Block-based predictive decoder of claim 45, wherein the features are derived in a frequency space.

66. Block-based predictive decoder of claim 45, wherein the features are derived by feeding the prediction block to a neural network.

67. Block-based predictive decoder of claim 45, wherein the features are a feature map that defines a mapping of its values to locations in the prediction block.

68. Block-based predictive decoder of claim 45, wherein feature values of the prediction block are individually derived for different rectangular sub-blocks or for different sub-areas.

69. Block-based predictive decoder of claim 45, wherein features are a vector comprising different features of the predicted block.

70. Block-based predictive decoder of claim 45, the prediction block is derived from reconstructed samples of spatial neighboring areas of the predicted block.

71. Block-based predictive encoder for encoding pictures into a data stream configured to derive a prediction residual block of a currently encoded block based on a predicted block of the currently encoded block so that the currently encoded block is reconstructable based on the prediction residual block and the predicted block.

72. Block-based predictive encoder of claim 71, configured to derive the prediction residual block of the currently encoded block based on the predicted block of the currently encoded block by
Extracting one or more features from the predicted block, and
Deriving the prediction residual block of the currently encoded block based on the one or more features.

73. Block-based predictive encoder of claim 71, configured to derive the prediction residual block of the currently encoded block based on the predicted block of the currently encoded block by
Selecting a predetermined transformation out of a set of transformations based on a prediction signal or one or more features derived therefrom,
Subjecting the prediction residual block of the currently encoded block to the predetermined transformation to obtain a transform representation, and
Encoding the transform representation into the data stream.

74. Block-based predictive encoder of claim 73, wherein the transformations comprise a number of machine learned transformations.

75. Block-based predictive encoder of claim 74, wherein the number of machine learned transformations depends on a size or shape of the currently encoded block.

76. Block-based predictive encoder of claim 73, configured to selecting the predetermined transformation out of the set of transformations by feeding a neural network or a predetermined function with the predicted block or one or more features derived from the predicted block.

77. Block-based predictive encoder of claim 73, configured to selecting the predetermined transformation out of the set of transformations by thresholding one or more features derived from the predicted block or by comparing them to different pre-defined values or value ranges.

78. Block-based predictive encoder of claim 71, configured to derive the prediction residual block of the currently encoded block based on the predicted block of the currently encoded block by
Determining a transformation based on the predicted block or one or more features derived therefrom,
Subjecting the prediction residual block of the currently encoded block to the transformation to obtain a transform representation, and
Encoding the transform representation into the data stream.

79. Block-based predictive encoder of claim 78, configured to determine the transformation based on the predicted block by feeding a neural network or a predetermined function with a prediction signal or one or more features derived from the predicted block or one or more features derived therefrom.

80. Block-based predictive encoder of claim 71, configured to derive the prediction residual block of the currently encoded block based on the predicted block of the currently encoded block by
Forming the prediction residual block of the currently encoded block depending on a prediction signal or one or more features derived therefrom,
Subjecting the prediction residual block of the currently encoded block to a transformation to obtain a transform representation, and
encoding the transform representation into the data stream.

81. Block-based predictive encoder of claim 80, configured to form the prediction residual block of the currently encoded block depending on the predicted block by one or more of
Setting the prediction residual block in one or more sample portions to a predetermined value such as zero, which one or more portions are positioned depending on the predicted block or one or more features derived therefrom,
cropping and/or shifting the prediction residual block in a manner depending on the predicted block or one or more features derived therefrom,
placing samples of the prediction residual block within the prediction residual block at a relative spatial arrangement which depends on the predicted block or one or more features derived therefrom,
filtering the prediction residual block by a filter parametrized depending on the predicted block or one or more features derived therefrom subjecting the prediction residual block to a neural network dependent on the predicted block or one or more features derived therefrom,
subjecting the prediction residual block and the predicted block or one or more features derived therefrom to a neural network.

82. Block-based predictive encoder of claim 71, configured to derive the prediction residual block of the currently encoded block based on the predicted block of the currently encoded block by
Subjecting the prediction residual block to a transformation to obtain a transform representation,
Modifying the transform representation depending on the predicted block or one or more features derived therefrom to obtain a modified transform representation, and
encoding the modified transform representation into the data stream.

83. Block-based predictive encoder of claim 82, configured to modify the transform representation depending on the predicted block by one or more of
Setting a subset of coefficients of the transform representation to a predetermined value such as zero, which one or more coefficients or predetermined values are identified depending on the predicted block,
Applying a secondary transform to the transform representation depending on the predicted block,
Applying a neural network to the transform representation depending on the predicted block.

84. Block-based predictive encoder of claim 71, configured to select a sub-partition of the currently encoded block based on the predicted block of the currently encoded block or based on one or more features derived from the predicted block using the prediction residual block for reconstruction of the sub-partition of the currently encoded block.

85. Block-based predictive encoder of claim 84, configured to derive a feature value per sub-partition of currently encoded block.

86. Block-based predictive encoder of claim 85, configured to select the sub-partition with highest or lowest feature value.

87. Block-based predictive encoder of claim 86 wherein the sub-partition are rectangular blocks.

88. Block-based predictive encoder of claim 71, wherein the one or more features include one or more of
A directionality measure of the predicted block,
Data derived from gradients of the predicted block,
Data derived from a histogram of gradient angels of the predicted block,
Data derived from Eigenvalues and/or Eigenvectors of a matrix, e.g., a covariance matrix, derived from gradient angels of the predicted block,
A spatial measure of the predicted block,
A map of local variances of the predicted block,
A magnitude of gradients of the predicted block,
The location of the maxima and minima in the predicted block,
The positions of edges in the predicted block,
A similarity of the predicted block to one or more pre-defined block templates.

89. Block-based predictive encoder of claim 71, wherein the predicted block is predicted from two or more prediction signals and the one or more features include one or more of
A similarity measure of (or between) the prediction signals,
A measure, e.g., a squared difference of the prediction signals, derived by comparing the prediction signals,
A measure derived from the combination of the prediction signals,
A measure derived by first deriving individual measures for the prediction signals and then combining the individual measures.

90. Block-based predictive encoder of claim 71, configured to derive a plurality of predicted blocks comprising the predicted block for the currently encoded block; and
derive the prediction residual block of the currently decoded block based on the predicted block;
wherein the currently encoded block is reconstructable based on the prediction residual block and the plurality of predicted blocks.

91. Block-based predictive encoder of claim 71, wherein the features are derived in a frequency space.

92. Block-based predictive encoder of claim 71, wherein the features are derived by feeding the prediction block to a neural network.

93. Block-based predictive encoder of claim 71, wherein the features are a feature map that defines a mapping of its values to locations in the prediction block.

94. Block-based predictive encoder of claim 71, wherein feature values of the prediction block are individually derived for different rectangular sub-blocks or for different sub-areas.

95. Block-based predictive encoder of claim 71, wherein features are a vector comprising different features of the predicted block.

96. Block-based predictive encoder of claim 71, the prediction block is derived from reconstructed samples of spatial neighboring areas of the predicted block.

97. Method performed by the apparatus of claim 45.

98. Method for decoding pictures from a data stream comprising
deriving a prediction residual block of a currently decoded block based on a predicted block of the currently decoded block, and
reconstructing the currently decoded block based on the prediction residual block and the predicted block.

99. Method performed by the apparatus of claim 71.

100. Method for encoding pictures into a data stream comprising deriving a prediction residual block of a currently encoded block based on a predicted block of the currently encoded block so that the currently encoded block is reconstructable based on the prediction residual block and the predicted block.

101. Data stream generated by the method of claim 98 or by the block-based predictive encoder of claim 71.

102. A computer program for implementing the method of claim 97 or 98 or 99 or 100 when being executed on a computer or signal processor.
